(19) United States
(12) Patent Application Publication
(10) Pub. No.: US 2010/0010869 A1
(43) Pub. Date: Jan. 14, 2010

(54) DEMAND CURVE ANALYSIS METHOD FOR PREDICTING FORECAST ERROR

(75) Inventors: Sylvain Faure, Huntington Beach, CA (US); Atul Mandal, Suwanee, GA (US)

Correspondence Address: DUANE MORRIS LLP - DC, 505 9th Street, Suite 1000, WASHINGTON, DC, 20004-2166, US

(73) Assignee: Plan4Demand Solutions, Inc., Suwanee, GA (US)

(21) Appl. No.: 12/419,585

(22) Filed: Apr. 7, 2009

Related U.S. Application Data
(60) Provisional application No. 61/043,332, filed on Apr. 8, 2008.

(51) Int. Cl. G06Q 10/00; G06Q 50/00; G06N 5/02

(52) U.S. Cl. 705/10; 706/52

(57) ABSTRACT

The present disclosure describes novel methods of demand planning for one or more products including estimating forecast error. The data may be organized into one or more hierarchies and may contain one or more attributes.

### RELATED APPLICATIONS

The instant application claims priority to and hereby incorporates by reference in its entirety co-pending U.S. Provisional Patent Application Ser. No. 61/043,332 entitled “Demand Curve Analyzer” filed on 8 Apr. 2008. Furthermore, the instant application is related to and hereby incorporates by reference in its entirety each of the following U.S. patent applications filed concurrently herewith: U.S. patent application Ser. No. ______ entitled “Demand Curve Analysis Method for Analyzing Demand Patterns” [PLA01 011] filed 7 Apr. 2009; and U.S. patent application Ser. No. ______ entitled “Demand Curve Analysis Method for Demand Planning” [PLA01 012] filed 7 Apr. 2009.

### BACKGROUND

Balancing supply and demand pressures is an increasingly important and difficult task for businesses to manage. Specifically, understanding demand curve behaviors is a critical task that must be closely monitored in order to effectively and efficiently run a business. Unfortunately, demand curve behaviors are dependent on a multitude of parameters any of which may change over different periods of time, such as weekly, monthly, seasonally, annually, etc. Such considerable differences in variability coupled with the large number of demand parameters results in a monumental challenge in predicting a product's future demand. Furthermore, some of the parameters may be dependent on one another, thereby adding further complexity to the problem. Consequently, accurate demand curve predictions over an appreciable time frame are extremely difficult to obtain.

Business managers typically lack the necessary understanding of the intricacies of demand curve prediction, such as demand curve variations, the interdependency of demand curve parameters, the variations in parameters over time, the level of accuracy of historical date, etc. Furthermore, managers typically do not have access to the information to help increase their level of understanding or the necessary tools to increase the accuracy of their demand curve predictions. Historically, managers predicted demand curves by only taking into account the gross variations in one or two of the demand factors and/or used a “gut feel” to predict future demand. Not surprisingly, such predictions often do not match actual demand for anything other than the very short term and therefore result in inefficiencies and lost profits for the business. Additionally, prior art systems and methodologies used to assist managers in accurately predicting demand curves also lacked the necessary.

Accordingly, there is a need for a system and method to increase the accuracy of demand curve predictions. The current disclosure is directed towards systems and methods to overcome the deficiencies in the prior art and to provide for various aspects of demand curve planning. In one aspect, the present disclosure describes novel systems and methods for analyzing demand patterns for one or more products based on time series data for the product(s) such as order history, shipment history, and point of sale history. The data may be organized into one or more hierarchies and may contain one or more attributes. A method for analyzing demand patterns may include gathering and preparing a time series of data and loading the data into a demand curve analysis (“DCA”) tool, setting a plurality of parameters to be used by the DCA tool, processing the time series of data with the DCA tool, and reviewing the output of the DCA tool.

In another aspect, the present disclosure describes novel systems and methods of demand planning for one or more products. This may include gathering and/or preparing a time series of data for a predetermined time period, generating categorizations of the data, determining the lumpiness of demand, determining seasonal tendencies of demand, determining trend tendencies of demand, testing the hygiene of the data, and determining a forecast of demand based on one or more of the lumpiness, seasonal tendencies, and/or trend tendencies of demand.

In yet another aspect, the present disclosure further describes other novel systems and method of demand planning including estimating the potential error reduction in a forecast of demand by determining forecast errors based on equivalent past time periods, determining an error threshold having an upper and lower confidence interval, calculating a potential forecast error reduction using a forecast of demand for the confidence intervals, and modifying the forecast with the estimated potential error reduction.

In still another aspect, the present disclosure further describes other novel systems and methods of demand planning including determining forecast smoothing tendencies, determining forecast bias tendencies, and determining forecast value added measures.

In yet still another aspect, the present disclosure describes novel systems and methods for estimating the predictability of demand for one or more products. This may include determining a coefficient of variation for a data series for a product and comparing the coefficient of variation to a scale that defines the predictability of demand for the product.

In a further aspect, the present disclosure describes novel systems and methods for estimating potential forecast error. This may include determining actual forecast error, computing calculated forecast errors, determining a variance of the calculated forecast errors to establish a threshold, and comparing the actual forecast error with the threshold to estimate the potential forecast error

In yet a further aspect, the present disclosure describes novel systems and methods for estimating potential forecast error improvement. This may include determining multiple actual forecast errors, computing calculated forecast errors, determining a threshold with an upper confidence interval and a lower confidence interval, and comparing the actual forecast errors with the threshold to estimate the potential forecast error improvement.

In still a further aspect, the present disclosure describes other novel systems and methods for estimating potential forecast error. This may include making a forecast for a predetermined time period, determining multiple actual forecast errors, calculating a mean squared error, determining an upper confidence interval and a lower confidence interval, and estimating the potential forecast error using the upper confidence interval and the lower confidence interval

In yet still a further aspect, the present disclosure describes further novel systems and methods for estimating potential forecast error. This may include determining an actual forecast error, making a forecast for a time period, estimating a potential forecast error for the time period, and comparing the actual forecast error with the potential forecast error.

The above advantages, as well as many other advantages, of the present disclosure will be readily apparent to one skilled in the art to which the disclosure pertains from a perusal of the claims, the appended drawings, and the following detailed description.

### BRIEF DESCRIPTION OF THE DRAWINGS

FIG. 1 is a flow diagram showing relationships between various entities in a supply chain and types of historical data for a method of analyzing demand patterns according to an embodiment of the disclosure.

FIG. 2 is a flow diagram showing expanded relationships between various entities in a supply chain and types of historical data for a method of analyzing demand patterns according to an embodiment of the disclosure.

FIG. 3 is a flow diagram for a method of analyzing demand patterns according to an embodiment of the disclosure.

FIG. 4 is a flow diagram for a method of analyzing demand patterns according to an embodiment of the disclosure.

FIG. 5 is a more detailed flow diagram for a method of analyzing demand patterns according to an embodiment of the disclosure.

FIG. 6 shows exemplary parameters for use in methods for analyzing demand patterns according to embodiments of the disclosure.

FIG. 7 is a flow diagram for a method of estimating the predictability of demand according to an embodiment of the disclosure.

FIG. 8 is a flow diagram for a method of demand planning according to an embodiment of the disclosure.

FIG. 9 is a flow diagram for a further method of demand planning according to an embodiment of the disclosure.

FIG. 10 shows exemplary plural characterizations and exemplary data hygiene testing combinations for use in methods for demand planning according to embodiments of the disclosure.

FIG. 11 is a flow diagram for a method of estimating potential forecast error according to an embodiment of the disclosure.

FIG. 12 is a flow diagram for a method of estimating potential forecast error according to an embodiment of the disclosure.

FIG. 13 is a flow diagram for a method of estimating potential forecast error according to an embodiment of the disclosure.

FIG. 14 is a flow diagram for another method of estimating potential forecast error according to an embodiment of the disclosure.

FIG. 15 is a flow diagram for yet another method of estimating potential forecast error according to an embodiment of the disclosure.

FIG. 16 is a four-quadrant graph illustrating a volume and variability profile for a product according to an embodiment of the disclosure.

### DETAILED DESCRIPTION

The current disclosure is directed towards systems and methods to overcome the deficiencies in the prior art and to provide for various aspects of demand curve planning as described herein with reference to the various Figures. Those of skill in the art will readily understand that the present disclosure is not necessarily limited to any actual examples stated herein but will encompass foreseeable variations and equivalents to those examples within the teaching of the spirit of the disclosure.

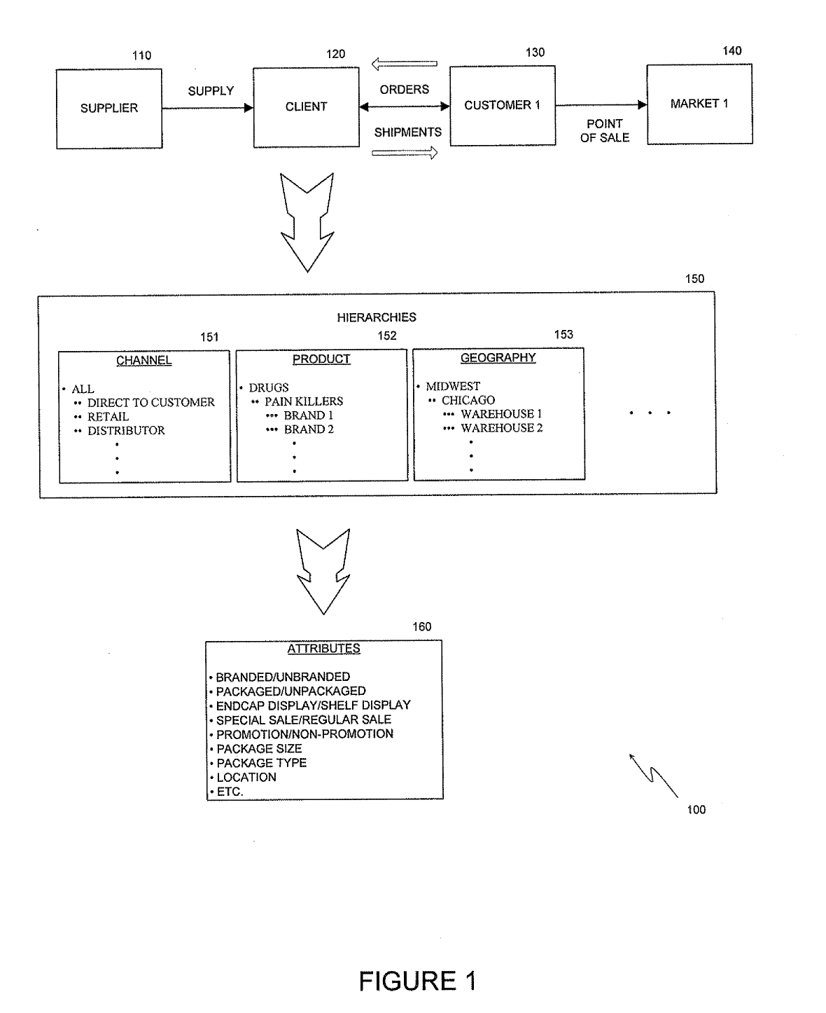

With attention directed towards FIG. 1, a flow diagram 100 is shown which indicates relationships between various entities in a supply chain and types of historical data for a method of analyzing demand patterns according to an embodiment of the disclosure. In this simplified version of a supply chain, a supplier 110 may supply one or more products to a client 120. The client 120 may ship the product(s) to a customer 130 typically in response to orders received by the client 120 from the customer 130. The customer 130 may then ship/transfer the product(s) to a market 140 for further disposition/sale. It shall be readily understood by those of skill in the art that this simplified version of a supply chain may include one or more suppliers 110, customers 130 and markets 140. Additionally, there may be additional suppliers upstream of the supplier 110 (e.g., an entity that supplies the product(s) to the supplier 110) as well as additional markets downstream of the market 140 (e.g., the market 140 may be a distributor who supplies the product(s) to further markets downstream). For the purposes of the present disclosure, the supply chain depicted in FIG. 1, and variations thereof may be applicable to gathering historical data for analyzing demand patterns for the product(s) of interest. The historical data may be for sales activities associated with the client 120 and/or sales activities associated with a competitor of the client 120. In an embodiment, the historical data from a competitor may be used, for example, to determine how the competitor's sales affect the client's sales.

One of skill in the art may readily understand that the simplified supply chain of FIG. 1 may represent the whole or any portion of an actual supply chain from which historical data may be gathered and analyzed, such as in a Demand Curve Analysis (“DCA”) tool. The DCA tool may comprise software, hardware, firmware, a microprocessor, or other similar devices or appliances for analyzing demand patterns and that references herein to “DCA tool” includes such similar software, hardware, firmware, microprocessors, devices, and/or appliances.

FIG. 1 further includes hierarchies 150 which may be used by the client 120 to distinguish a product for which a demand pattern is being analyzed. The hierarchies 150 may include, but are not limited to, the exemplary hierarchies depicted such as channel of sale 15 1, product 152, and geography 153. The channel of sale hierarchy 151 may include, but is not limited to, direct sales to customers, such as the customer 130, retail sales, sales to distributors, and other sales channels. The product hierarchy 152 may include various products for which a demand pattern is to be analyzed. For example, the exemplary product hierarchy 152 may include at a first categorical level for the product(s) of interest, such as “drugs”, as shown, which may be broken down into sub-categories such as “pain killers” which, in turn, may be further broken down into sub-sub-categories such as “brand 1”, “brand 2”, etc. The geographic hierarchy 153 may include various levels of geographic regions such as “Midwest” which may be broken down into cities/towns such as “Chicago” and further broken down into specific depots, for example, such as “warehouse 1” and “warehouse 2” as shown. Those of skill in the art will readily understand that the present disclosure is in no way limited to the exemplary hierarchies and sub-hierarchies listed above but rather is applicable to a wide range of sales channels, products, geographies, and other hierarchies that would be useful in assessing demand patterns.

The product hierarchy may additionally have associated therewith a number of attributes 160 which may be useful in analyzing a demand pattern for the product(s) of interest. For example, the attributes 160 may include, but are not limited to, information regarding whether one or more product(s) are branded or unbranded, packaged or unpackaged, displayed in an endcap display or on a regular shelf display, whether the product(s) are to be sold as part of a special sale (e.g., Labor Day Sale, President's Day Sale, etc.) or simply regularly sold, whether there is a particular promotion or advertisement associated with the product(s) or not, a size or type of package in which the product(s) are sold, a location in the store in which the product(s) are to be sold, etc. As will be readily understood by one of skill in the art, the above exemplary attributes are not limiting and not all of the above attributes may be used in conjunction with a particular product. Other attributes may be used with specific products that may not be applicable with other products. Furthermore, attributes may be used with any of the hierarchies 150 and are not limited to the product hierarchy 152. The attributes chosen may be based solely on the availability and/or quality of historical data associated with those attributes for the hierarchies of interest in a demand pattern analysis as discussed herein.

The historical data to be analyzed may be collected and evaluated in one or more “time buckets”, i.e., durations of time. For example, the time bucket for the historical data may be based on any convenient time duration, such as daily, weekly, monthly, quarterly, semi-annually, annually, etc. The choice of the size of the time bucket may be dictated by the type and extent of historical data available for the product(s) of interest. Furthermore, the size of the time bucket chosen for the demand pattern analysis may affect the results of the analysis. In one non-limiting embodiment, historical data used for analyzing a demand pattern using a DCA tool may require two or more years of data in order to be able to ascertain historical demand pattern trends. In a further non-limiting embodiment, a demand pattern analysis using a DCA tool may be limited to a total of ten attributes for each of three hierarchies.

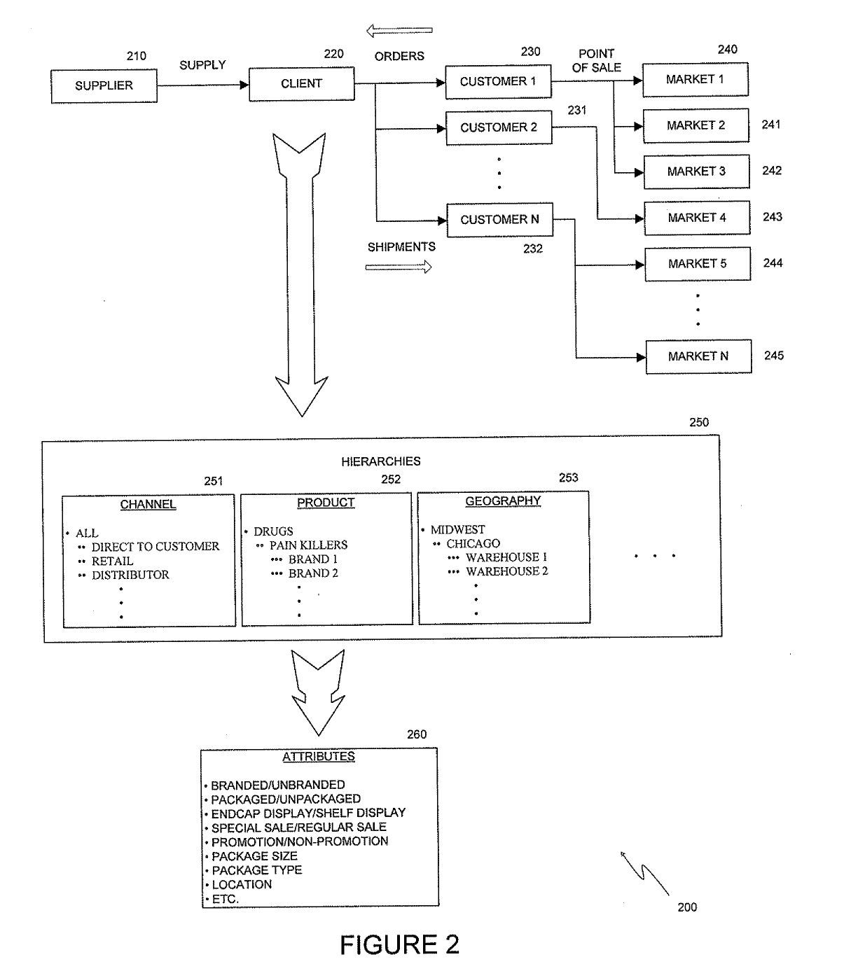

With reference now directed toward FIG. 2, a flow diagram 200 is shown depicting expanded relationships between various entities in a supply chain and types of historical data for a method of analyzing demand patterns according to an embodiment of the disclosure. In this more detailed version of a supply chain, a supplier 210 may supply one or more products to a client 220. The client 220 may ship the product(s) to multiple customers, such as customer 1 (230), customer 2 (231), and customer N (232) typically in response to orders received by the client 220 from the customers 230, 231, and 232. ). Each of the customers 230, 231, and 232 may then ship/transfer the product(s) to one or more markets. As shown in the exemplary supply chain in FIG. 2, the customer 230 may ship/transfer the product(s) to market 1 (240), market 2 (241), and market 3 (242). Similarly, the customer 231 may ship/transfer the product(s) to market 4 (243) which the customer 232 may ship/transfer the product(s) to market 5 (244) and other markets up to and including market N (245). It shall be readily understood by those of skill in the art that this more detailed version of a supply chain may further include one or more suppliers 210. Additionally, there may be additional suppliers upstream of the supplier 210 (e.g., an entity that supplies the product(s) to the supplier 210) as well as additional markets downstream of the markets 240-245 (e.g., the market 240 may be a distributor who supplies the product(s) to further markets downstream). For the purposes of the present disclosure, the supply chain depicted in FIG. 2, and variations thereof, may be applicable to gathering historical data for analyzing demand patterns for the product(s) of interest. Therefore, one of skill in the art may readily understand that the simplified supply chain of FIG. 2 may represent the whole or any portion of an actual supply chain from which historical data may be gathered and analyzed, such as in a Demand Curve Analysis (“DCA”) tool. The DCA tool may comprise software, hardware, firmware, a microprocessor, or other similar devices or appliances for analyzing demand patterns.

FIG. 2 also includes hierarchies 250 and attributes 260 which are similar to hierarchies 150 and attributes 160, respectively, as discussed above with respect to FIG. 1. That discussion is incorporate herein with respect to FIG. 2.

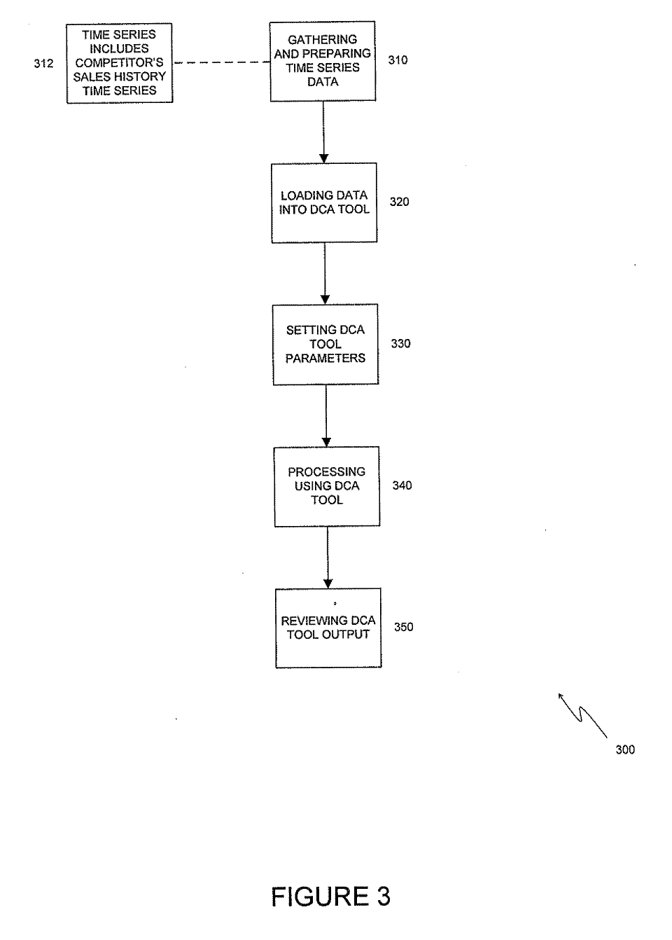

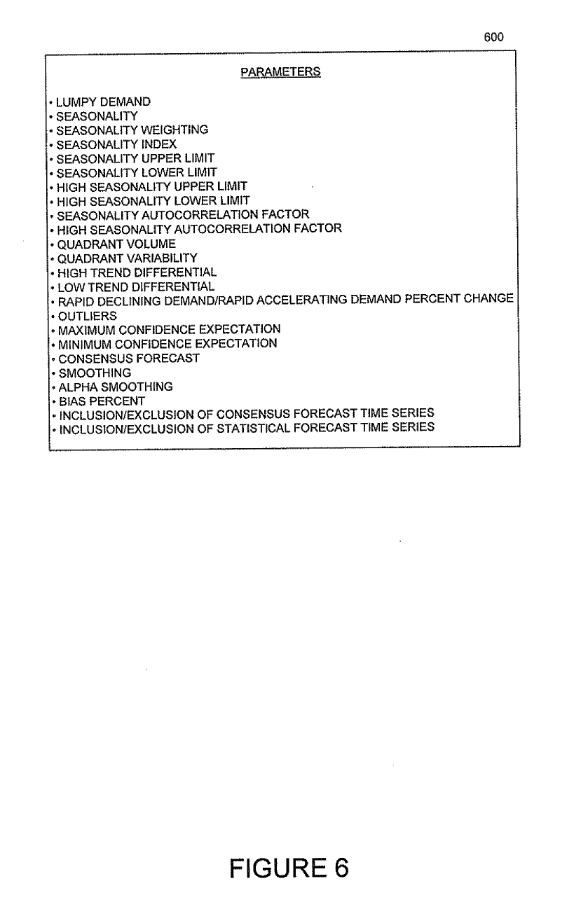

FIG. 3 depicts a flow diagram 300 for a method of analyzing demand patterns according to an embodiment of the disclosure. The method may be performed on a DCA tool, as discussed above. At block 310 time series data useful for analyzing demand patterns of one or more products may be gathered and/or prepared for analysis. At block 320 the time series data may be loaded into a DCA tool or other similar software program, hardware device, or similar appliance capable of performing the necessary analysis of the time series data. At block 330 one or more parameters to be used by the DCA tool may be set. These parameters will be discussed in further detail below with respect to FIG. 6. At block 340 the time series data may be processed using the DCA tool.

Furthermore, in another embodiment of the disclosure the time series input data may include sales history time series data for a competitor of the entity for which a demand pattern is being determined/analyzed. For instance, the historical (e.g., time series) data in block 310 may be for sales activities associated with the client 120 in FIG. 1, as discussed above. In addition to the client's historical data, historical data for a competitor in block 312 may also be used in the method for analyzing the client's demand patterns.

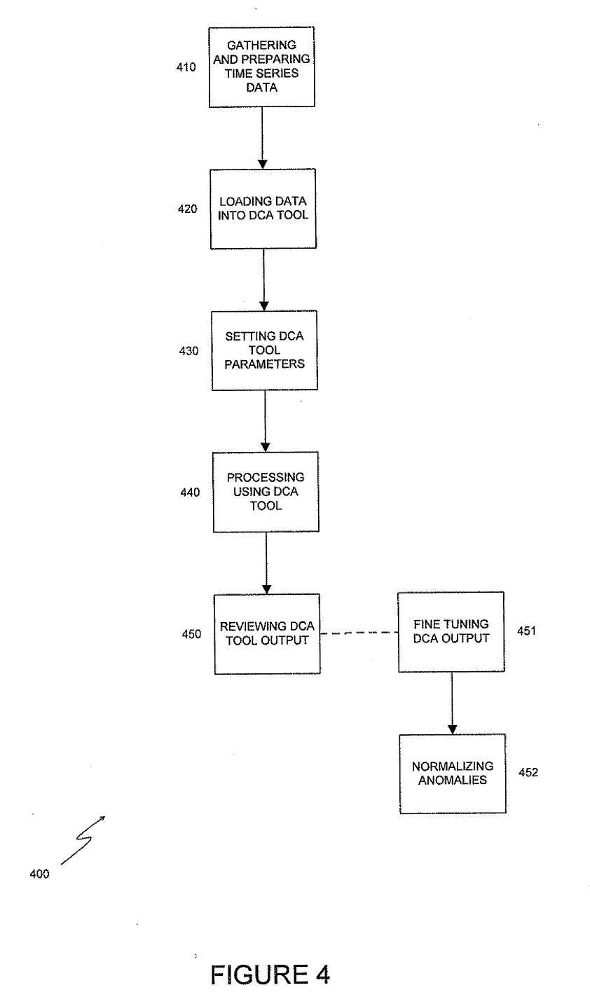

FIG. 4 depicts a flow diagram 400 for a method of analyzing demand patterns according to an embodiment of the disclosure. Blocks 410, 420, 430, 440, and 450 are similar to blocks 310, 320, 330, 340, and 350, respectively, as discussed above with respect to FIG. 3. At block 451 the output of the DCA tool may be reviewed and/or fine tuned. As a non-limiting example, at block 452 the output of the DCA tool may be fine-tuned to account for inaccurate and/or incomplete time series input data to thereby normalize any anomalies in the DCA tool output that cannot be supported by statistical data based on the time series input data.

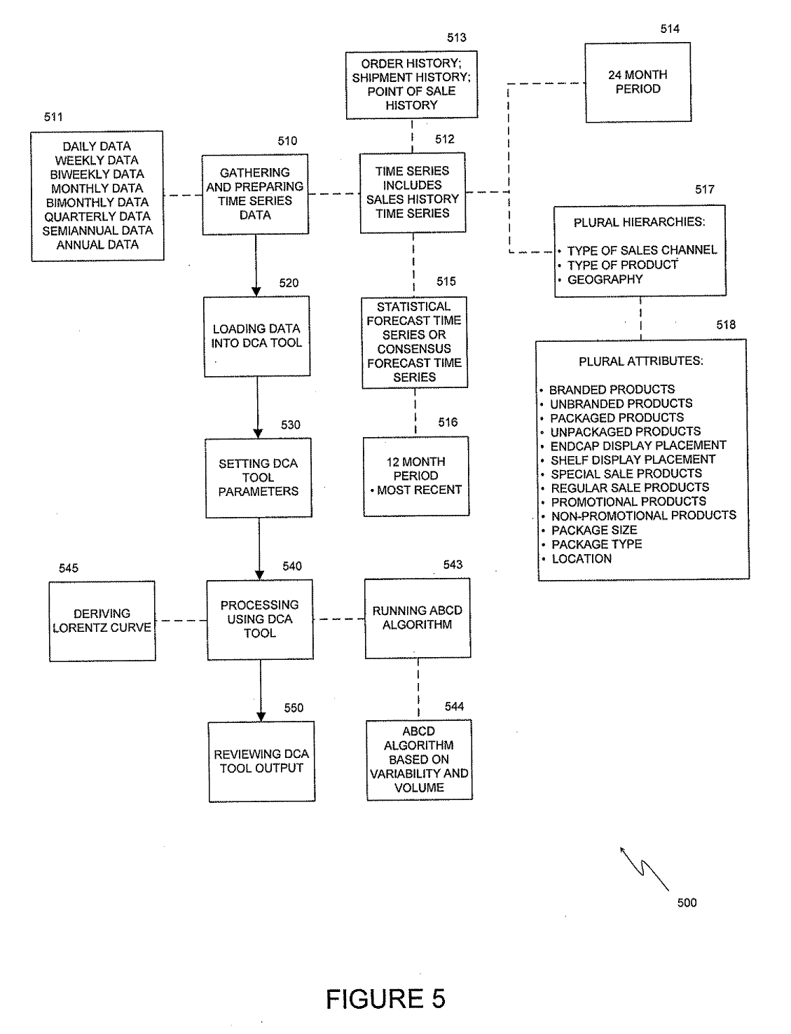

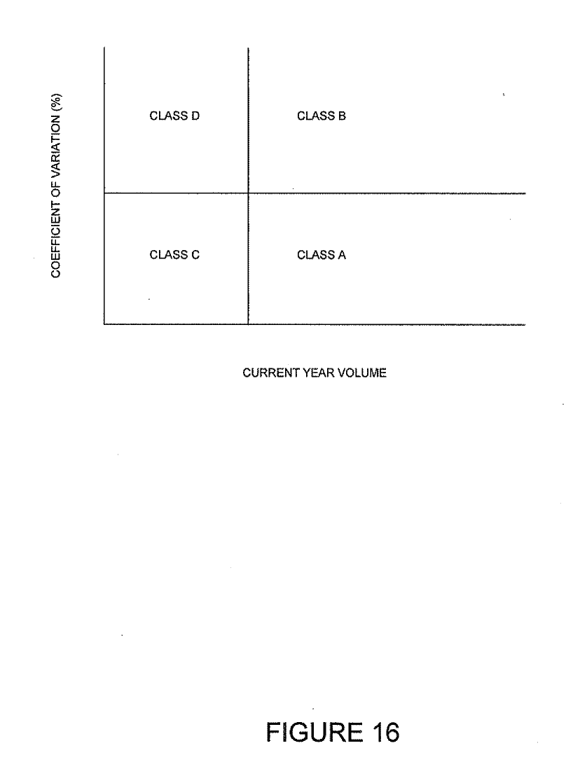

With attention now directed towards FIG. 5, a more detailed flow diagram 500 is shown for a method of analyzing demand patterns according to an embodiment of the disclosure. In this flow diagram, blocks 510, 520, 530, 540, and 550 are similar to blocks 310, 320, 330, 340, and 350, respectively, as discussed above with respect to FIG. 3. At block 543 the processing performed using the DCA tool at block 540 may include running an ABCD algorithm. At block 544 the ABCD algorithm may be used to produce a quadrant graph on the time series data based on variability and volume in the format shown in FIG. 16. The details of the quadrant graph will be discussed further below. At block 545, the processing performed at block 540 may include deriving a Lorenz curve from the time series data. At block 511, the time series data that may be gathered and prepared in block 5 10 may include data selected from a particular time bucket, such as daily data, weekly data, biweekly data, monthly data, bimonthly data, quarterly data, semiannual data, annual data, or any other convenient time duration. At block 512 the time series data that may be gathered and prepared in block 510 may include sales history time series data for at least one product. In an embodiment, the sales history time series may include data from at least a twenty-four month period. At block 513, the sales history time series data may include one or more of order history, shipment history, and point of sale history data.

At block 517 the sales history time series data may include data for one or more hierarchies, where the hierarchies may be a type of sales channel, a type of product, or a geographic area. At block 518, the data for the hierarchies in block 517 may include data for one or more attributes, as discussed above with respect to block 160 in FIG. 1. The attributes 518 may include, but are not limited to, information regarding whether one or more product(s) are branded or unbranded, packaged or unpackaged, displayed in an endcap display or on a regular shelf display, whether the product(s) are to be sold as part of a special sale or simply regularly sold, whether there is a particular promotion or advertisement associated with the product(s) or not, a size or type of package in which the product(s) are sold, a location in the store in which the product(s) are to be sold, etc. As will be readily understood by one of skill in the art, the above exemplary attributes are not limiting and not all of the above attributes may be used in conjunction with a particular product. Other attributes may be used with specific products that may not be applicable with other products. Furthermore, attributes may be used with any of the hierarchies 517 and are not limited to the product hierarchy. In a particular embodiment, the number of hierarchies may equal three and the total number of attributes may equal ten.

With reference still directed towards FIG. 5, the sales history time series data of blok 512 may include at least one of a statistical forecast time series and a consensus forecast time series, as those time series are known in the art. In particular embodiments, either one or both of the statistical forecast time series and the consensus forecast time series may include data from at least a twelve month period, preferably from the most recent twelve month period.

Now considering FIG. 6, exemplary parameters 600 are shown which may be used for methods for analyzing demand patterns according to embodiments of the disclosure. In particular, at block 530 of FIG. 5, certain parameters may be set in the DCA tool for the analysis of demand patterns. These parameters may be selected by an operator of the DCA tool and may include one of more of the following exemplary parameters: lumpy demand, seasonality, seasonality weighting, seasonality index, seasonality upper limit, seasonality lower limit, high seasonality upper limit, high seasonality lower limit, Seasonality Autocorrelation factor, High Seasonality Autocorrelation factor, quadrant volume, quadrant variability, high trend differential, low trend differential, RDD (Rapid Declining Demand)/RAD (Rapid Accelerating Demand) percent change, outliers, maximum confidence expectation, minimum confidence expectation, consensus forecast smoothing, and alpha smoothing, bias percent, inclusion/exclusion of consensus forecast time series, and inclusion/exclusion of statistical forecast time series. One of skill in the art will readily understand that other parameters applicable to demand pattern analysis may be set in the DCA tool.

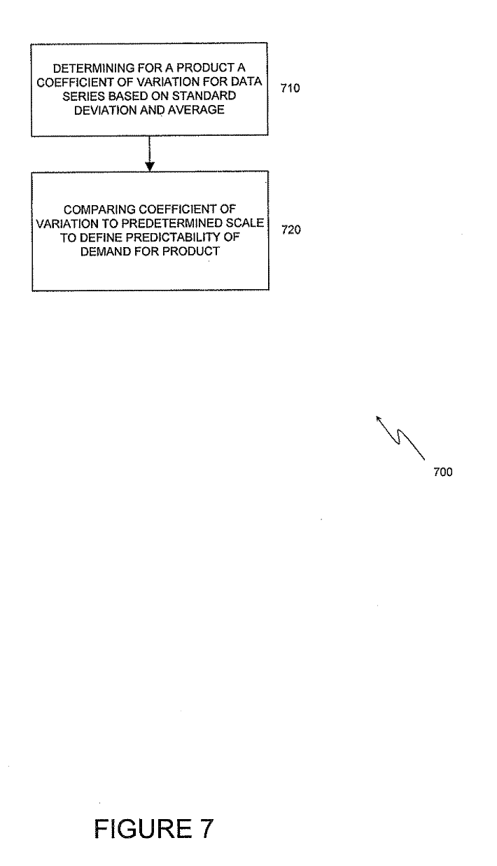

FIG. 7 is a flow diagram for a method of estimating the predictability of demand for at least one product according to an embodiment of the disclosure. At block 710 a determination may be made for a coefficient of variation for a data series for a predetermined product or products. The coefficient of variation may be defined by at least one of a standard of deviation of the data series for the product(s) and an average of the data series for the product(s). At block 720, a comparison may be made between the coefficient of variation determined in block 710 and a predetermined scale where the scale may be useful in defining the predictability of demand for the predetermined product(s). Thus, the coefficient of variation can then be measured to thereby estimate the predictability of demand for the predetermined product(s).

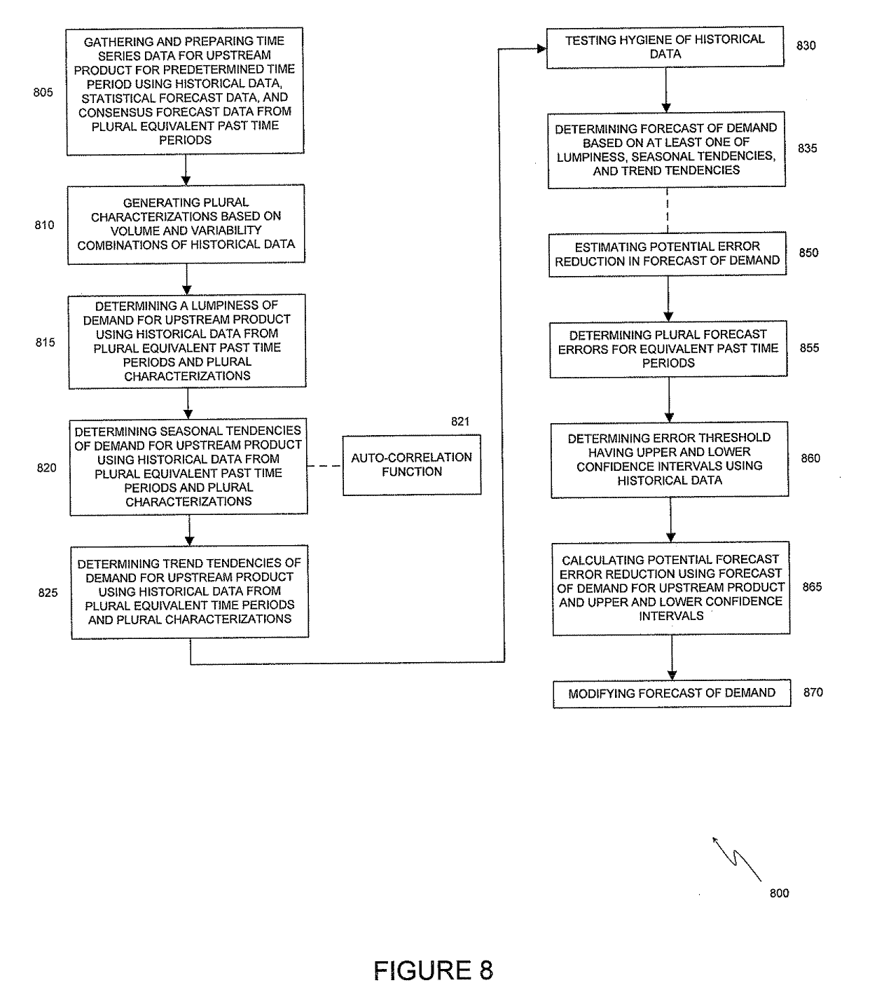

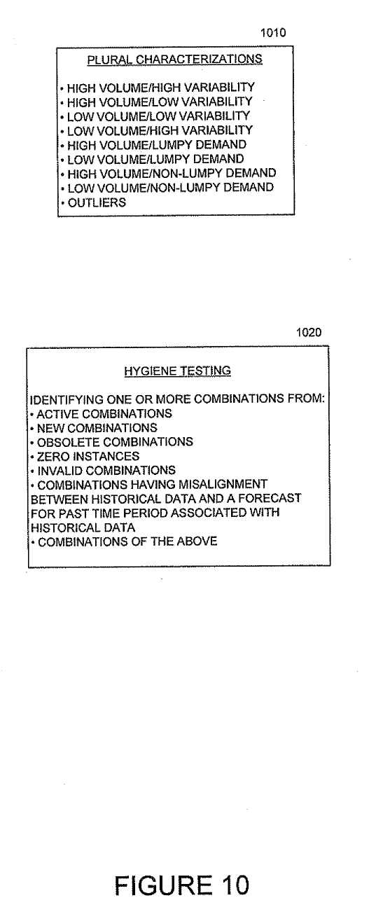

Taking into account FIG. 8, flow diagram 800 represents a method of demand planning for at least one product according to an embodiment of the disclosure. In an embodiment, the demand planning may take into account one or more time series data sets for a product or products which may be categorized based on volume and/or variability combinations of the time series data, Additionally, the demand planning may include determinations of lumpiness of demand, seasonal tendencies of demand, and trend tendencies of demand. The data used for the demand planning may be tested for hygiene, as will be discussed further with respect to FIG. 10. At block 805 time series data for at least one product for a predetermined period of time may be gathered and/or prepared. The time series data may include upstream data (e.g., data from the supplier 110 to the client 120 in FIG. 1) for the product(s). Furthermore, the time series data may include at least one of historical data, statistical forecast data, and consensus data from one or more past time periods, which may be referred to hereinafter, individually or collectively, as historical data. The time periods may be equivalent. At block 810 one or more characterizations of the historical data may be generated. The characterizations may be based on volume and variability combinations of the historical data and are discussed further below with respect to FIG. 10. At block 815 a lumpiness of demand may be determined for the product(s). The lumpiness of demand may be determined based on the data from the one or more past time periods and/or may also take into account the one or more characterizations of the historical data. At block 820 seasonal tendencies of demand may be determined based on the data from the one or more past time periods and/or may also take into account the one or more characterizations of the historical data. At block 825 trend tendencies of demand may be determined based on the data from the one or more past time periods and/or may also take into account the one or more characterizations of the historical data. At block 830, the historical data may be undergo hygiene testing. At block 835 a forecast of demand may be determined that is based on at least one of the following determinations: lumpiness of demand, seasonal tendencies of demand, and trend tendencies of demand.

Moreover, another embodiment for demand planning according to the disclosure may include, at block 850, estimating a potential error reduction in the forecast of demand from block 835. The estimation of a potential error reduction may include: at block 855, determining one or more forecast errors which may correspond to one or more of the equivalent past time periods; at block 860, determining an error threshold for the historical data where the error threshold has an upper confidence interval and a lower confidence interval; and, at block 865, calculating a potential forecast error reduction for at least one of the determined forecast errors using the forecast of demand and one or both of the upper and lower confidence intervals. At block 870 the forecast of demand may be modified by the calculated forecast error reduction. In another embodiment, the determining of seasonal tendencies of demand may include evaluating the historical data using an auto-correlation function, which may be set to be equal to 0.3.

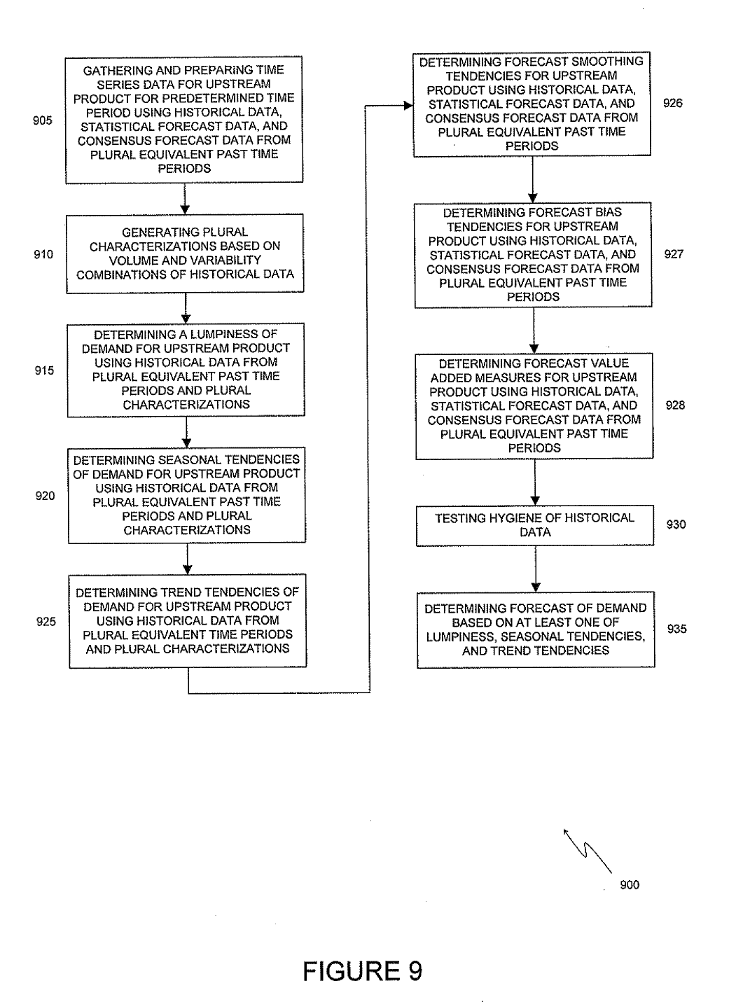

Looking now towards FIG. 9, flow diagram 900 represents a further method of demand planning according to an embodiment of the disclosure. Blocks 905, 910, 915, 920, 925, 930, and 935 are similar to blocks 805, 810, 815, 820, 825, 830, and 835 respectively, as discussed above with respect to FIG. 8. At block 926 forecast smoothing tendencies for the product(s) may be determined using at least one of historical data, statistical forecast data, and consensus forecast data from the past time periods, where the past time periods may be equivalent. At block 927 forecast bias tendencies for the product(s) may be determined using at least one of historical data, statistical forecast data, and consensus forecast data from the past time periods, where the past time periods may be equivalent. At block 928 forecast value added measures for the product(s) may be determined using at least one of historical data, statistical forecast data, and consensus forecast data from the past time periods, where the past time periods may be equivalent. At block 935 a forecast of demand may be determined that is based on at least one of the following determinations: lumpiness of demand, seasonal tendencies of demand, and trend tendencies of demand, taking into account one or more of the forecast smoothing tendencies, forecast bias tendencies, and forecast value added measures.

FIG. 10 shows exemplary plural characterizations 1010 and exemplary data hygiene testing combinations 1020 for use in methods for demand planning according to embodiments of the disclosure. The one or more characterizations that may be generated in block 810 in FIG. 8 may be based on volume and variability combinations of historical data. At block 1010, these characterizations may include high volume/high variability, low volume/low variability, low volume/high variability, and high volume/low variability, high volume/lumpy demand, low volume/lumpy demand, low volume/none lumpy demand, high volume/none lumpy demand, and outliers. These characterizations may be visualized graphically in the quad graph depicted in FIG. 16 where the abscissa is a measure of product volume, such as, for example, the current year volume, and the ordinate is a measure of the coefficient of variation of the product which may be measured in, for example, a percentage. For example, Class A products would be those products that have a high volume and a low coefficient of variation. Class B products would be those products that have a high volume and a high coefficient of variation. Class C products would be those products that have a low volume and a low coefficient of variation. Class D products would be those products that have a low volume and a high coefficient of variation.

With attention now back to FIG. 10, testing the hygiene of the historical data that may be performed in block 830 in FIG. 8 may include, at block 1020, identifying one or more combinations such as, but not limited to, active combinations, new combinations, obsolete combinations, zero instances, invalid combinations, combinations where there is misalignment between said historical data and a forecast for said past time period associated with said historical data, and combinations thereof.

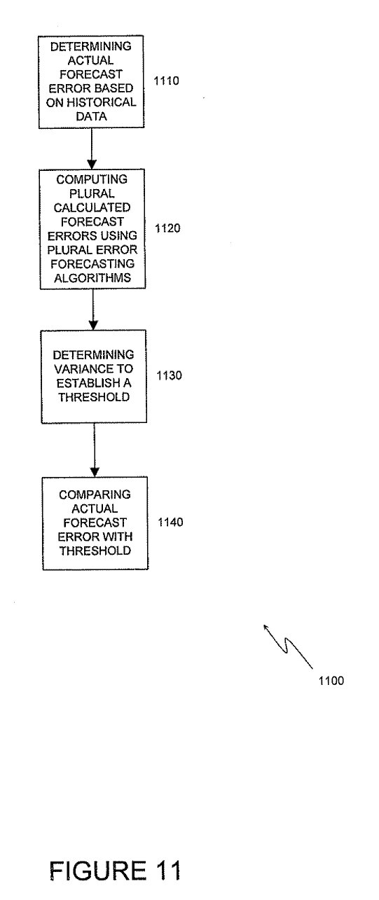

In FIG. 11 a flow diagram 1100 is shown representing a method of estimating potential forecast error according to an embodiment of the disclosure. At block 1110 an actual forecast error may be determined based on historical data for one or more products. At block 1120 one or more forecast errors for the product(s) may be computed based on the results of one or more error forecasting algorithms. At block 1130 a variance of the forecast errors may be determined to thereby establish a threshold value. At block 1140 the actual forecast error may be compared to the threshold value to thereby estimate a potential forecast error for the product(s).

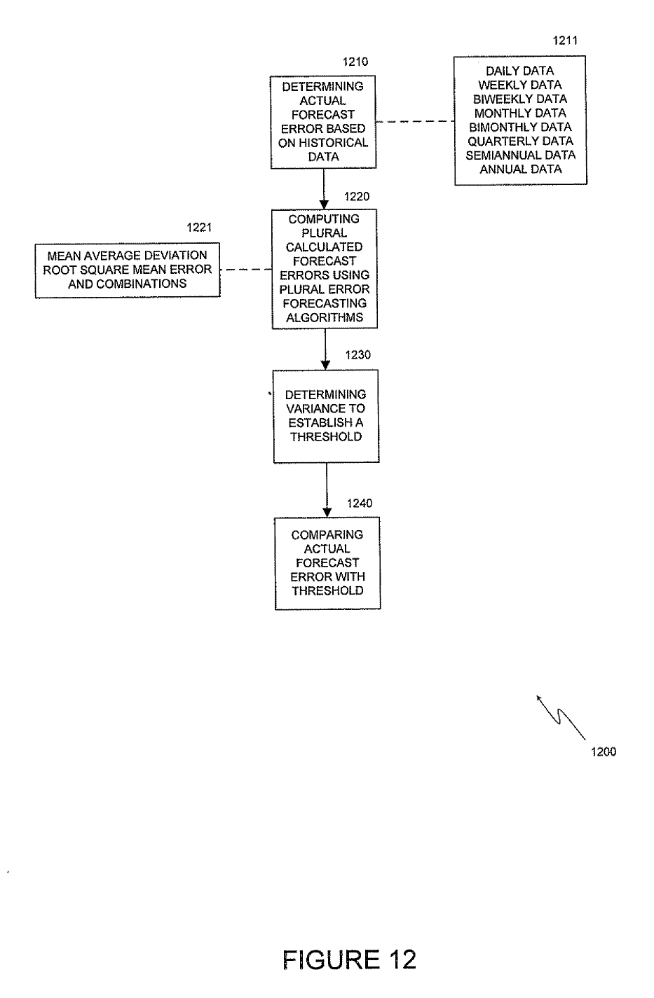

FIG. 12 shows a flow diagram 1200 for a method of estimating potential forecast error according to an embodiment of the disclosure. Blocks 1210, 1220, 1230, and 1240 are similar to blocks 1110, 1120, 1130, and 1140 respectively, as discussed above with respect to FIG. 11. At block 1211, the historical data used for determining an actual forecast error in block 1210 may be collected and evaluated in one or more “time buckets”, i.e., durations of time, as discussed above. For example, the time bucket for the historical data may be based on any convenient time duration, such as daily, weekly, biweekly, monthly, bimonthly, quarterly, semi-annually, annually, etc. At block 1221 the error forecasting algorithms used in block 1220 for computing forecast errors may include a mean average deviation, a root square mean error, or a combination of the two. Those of skill in the art will readily understand that other error forecasting algorithms are contemplated herein.

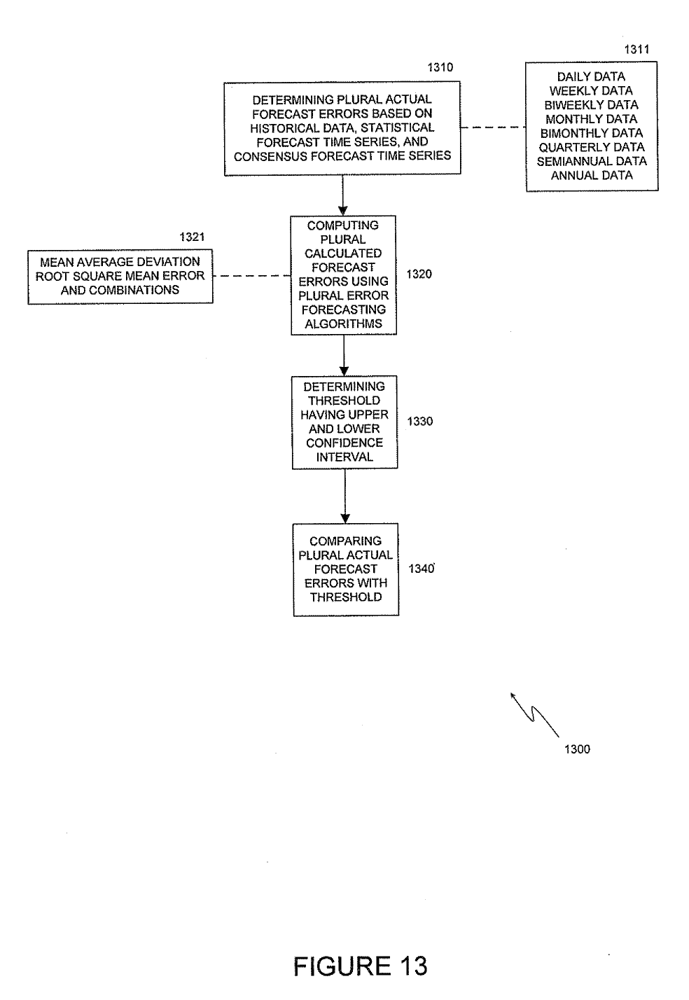

With respect to FIG. 13, a flow diagram 1300 is shown for a method of estimating potential forecast error according to an embodiment of the disclosure. At block 1310 one or more actual forecast errors may be determined based on at least one of historical data for one or more products, statistical forecast time series data, and consensus forecast time series data. At block 1320 one or more calculated forecast errors may be computed for the product(s) using one or more error forecasting algorithms. At block 1330 a threshold may be determined for the historical data where the threshold has an upper confidence interval and a lower confidence interval. At block 1340 the one or more actual forecast errors may be compared with the threshold to thereby estimate a potential forecast error improvement for the product(s). At block 1311, the historical data used for determining the one or more actual forecast errors in block 1310 may be collected and evaluated in one or more “time buckets”, i.e., durations of time, as discussed above. For example, the time bucket for the historical data may be based on any convenient time duration, such as daily, weekly, biweekly, monthly, bimonthly, quarterly, semi-annually, annually, etc. At block 1321 the error forecasting algorithms used in block 1320 for computing forecast errors may include a mean average deviation, a root square mean error, or a combination of the two. Those of skill in the art will readily understand that other error forecasting algorithms are contemplated herein.

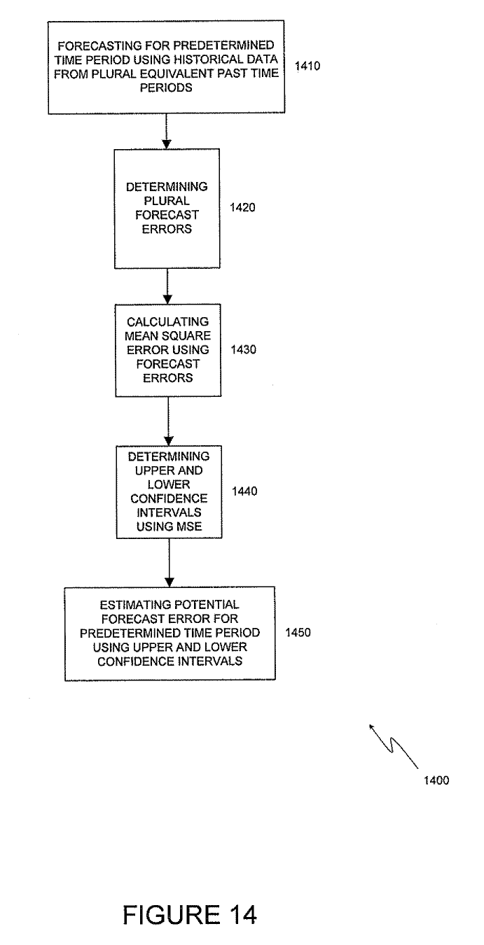

Considering FIG. 14, is a flow diagram 1400 is shown representing another method of estimating potential forecast error according to an embodiment of the disclosure. At block 1410 a forecast may be made for a predetermined time period using historical data for one or more products for past time periods, where the past time periods may be equivalent. At block 1420 one or more forecast errors may be determined for the product(s) and the forecast errors may each correspond to one of the past time periods. At block 1430 a mean square error may be calculated using the one or more forecast errors. At block 1440 an upper confidence interval and a lower confidence interval may be determined using the mean square error. At block 1450 a potential forecast error may be estimated for the product(s) based on the forecast determined in block 1410 and the upper and lower confidence intervals determined in block 1440.

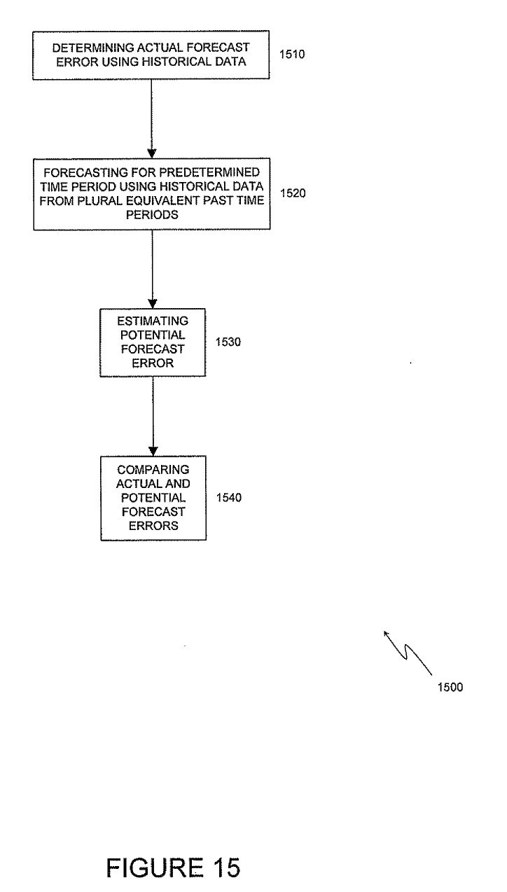

With attention now directed towards FIG. 15, a flow diagram 1500 is shown for yet another method of estimating potential forecast error according to an embodiment of the disclosure. At block 1510 an actual forecast error may be determined based on historical data for one or more products. At block 1520 a forecast may be made for a predetermined time period using the historical data for the product(s) from past time periods, where the past time periods may be equivalent. At block 1530 a potential forecast error may be estimated using the forecast determined in block 1520. At block 1540 the actual forecast error determined in block 1510 may be compared with the potential forecast error estimated in block 1530.

While preferred embodiments of the present disclosure have been described, it is to be understood that the embodiments described are illustrative only and that the scope of the invention is to be defined solely by the appended claims when accorded a full range of equivalents, many variations and modifications naturally occurring to those of skill in the art from a perusal hereof.

We claim:

1. A method for estimating potential forecast error for at least one product, comprising the steps of:
(a) determining an actual forecast error based on historical data for said at least one product;
(b) computing a plurality of calculated forecast errors for said at least one product using a plurality of error forecasting algorithms;
(c) determining a variance of said plurality of calculated forecast errors to establish a threshold; and
(d) comparing said actual forecast error with said threshold to estimate potential forecast error for said at least one product.

2. The method according to claim 1 wherein said historical data for said at least one product is selected from the group consisting of: daily data, weekly data, biweekly data, monthly data, bimonthly data, quarterly data, semiannual data, and annual data.

3. The method according to claim 1 wherein said plurality of error forecasting algorithms includes at least one algorithm selected from the group consisting of: MAD (Mean Average Deviation), RSME (Root Square Mean Error), and combinations thereof.

4. The method according to claim 1 wherein said historical data includes at least one member selected from the group consisting of: order history, shipment history, and point of sale history.

5. The method according to claim 4 wherein said historical data comprises data from a plurality of hierarchies.

6. The method according to claim 5 wherein said hierarchies are selected from the group consisting of: type of sales channel, type of product, geography, and combinations thereof.

7. The method according to claim 5 wherein said data from a plurality of hierarchies comprises data from a plurality of attributes.

8. The method according to claim 7 wherein said attributes are selected from the group consisting of: branded products, unbranded products, packaged products, unpackaged products, endcap display placement, shelf display placement, special sale products, regular sale products, promotional products, non-promotional products, package size, package type, location, and combinations thereof.

9. The method according to claim 7 wherein said plurality of hierarchies equals three (3) and said plurality of attributes equals ten (10).

10. A method for estimating potential forecast error improvement for at least one product, comprising the steps of:
(a) determining a plurality of actual forecast errors based on historical data for said at least one product, statistical forecast time series and a consensus forecast time series;
(b) computing a plurality of calculated forecast errors for said at least one product using a plurality of error forecasting algorithms;
(c) determine a threshold comprising an upper confidence interval and a lower confidence interval using said historical data; and
(d) comparing said plurality of actual forecast errors with said threshold to estimate a potential forecast error improvement for said at least one product.

11. The method according to claim 10 wherein said historical data statistical forecast time series and a consensus forecast time series are selected from the group consisting of: daily data, weekly data, biweekly data, monthly data, bimonthly data, quarterly data, semiannual data, and annual data.

12. The method according to claim 10 wherein said plurality of error forecasting algorithms includes at least one algorithm selected from the group consisting of: MAD (Mean Average Deviation), RSME (Root Square Mean Error), and combinations thereof.

13. The method according to claim 10 wherein said historical data includes at least one member selected from the group consisting of: order history, shipment history, and point of sale history.

14. The method according to claim 13 wherein said historical data comprises data from a plurality of hierarchies.

15. The method according to claim 14 wherein said hierarchies are selected from the group consisting of: type of sales channel, type of product, geography, and combinations thereof.

16. The method according to claim 14 wherein said data from a plurality of hierarchies comprises data from a plurality of attributes.

17. The method according to claim 16 wherein said attributes are selected from the group consisting of: branded products, unbranded products, packaged products, unpackaged products, endcap display placement, shelf display placement, special sale products, regular sale products, promotional products, non-promotional products, package size, package type, location, and combinations thereof.

18. The method according to claim 16 wherein said plurality of hierarchies equals three (3) and said plurality of attributes equals ten (10).

19. A method for estimating potential forecast error for at least one product, comprising the steps of:
(a) making a forecast for a predetermined time period using historical data for said at least one product from a plurality of equivalent past time periods;
(b) determining a plurality of forecast errors for said at least one product, wherein each of said plurality of forecast errors corresponds to one of said plurality of equivalent past time periods;
(c) calculating a Mean Squared Error (MSE) using said plurality of forecast errors;
(d) determining an upper confidence interval and a lower confidence interval using said MSE; and
(e) estimating said potential forecast error for said at least one product using said forecast for a predetermined time period and said upper confidence interval and said lower confidence interval.

20. A method for estimating potential forecast error for at least one product, comprising the steps of:
(a) determining an actual forecast error based on historical data for said at least one product;
(b) making a forecast for a predetermined time period using historical data for said at least one product from a plurality of equivalent past time periods;
(c) estimating a potential forecast error using said forecast for a predetermined time period; and
(d) comparing said actual forecast error with said potential forecast error.
